(19) United States
(12) Patent Application Publication
(10) Pub. No.: US 2009/0095660 A1
(43) Pub. Date: Apr. 16, 2009

(54) NEW APPLICATIONS FOR FROTH FLOTATION PROCESSES

(75) Inventors: Stephen C. Paspek, JR., Broadview Heights, OH (US); Joseph E. Bork, Westlake, OH (US); Alan Schroeder, Cleveland, OH (US); Christopher Kulbago, Broadview Heights, OH (US)

Correspondence Address: RANKIN, HILL & CLARK LLP, 38210 Glenn Avenue, WILLOUGHBY, OH, 44094-7808, US

(73) Assignee: BROADVIEW GROUP, LLC, Broadview Heights, OH (US)

(21) Appl. No.: 12/250,200

(22) Filed: Oct. 13, 2008

Related U.S. Application Data
(60) Provisional application No. 60/979,244, filed on Oct. 11, 2007.

(51) Int. Cl. B03B 5/60; B03D 1/008; B03D 1/02

(52) U.S. Cl. 209/167; 209/164; 521/46.5

(57) ABSTRACT

A process is described for the separation of fluorinated plastic particles from a mixture of solid particles of similar specific gravity. The process comprises mixing the particles with water, adding air to create bubbles, and generating two or more product streams, one of which floats and the other which sinks. The floating stream is enriched in fluoropolymer particles. Per pass yield and selectivity of fluorinated plastics are enhanced by the addition of a carboxylic acid to the froth flotation medium.

### CROSS REFERENCES TO RELATED APPLICATIONS

This application claims priority upon U.S. provisional application filed on Oct. 11, 2007 as U.S. provisional Ser. No. 60/979,244.

### FIELD OF THE INVENTION

The present invention relates to reclaiming one or more fluorinated solid components, such as fluorinated plastics, from a mixture of components in which at least some the components have the same or similar densities as the fluorinated plastics. Recovery of particulate fluorinated plastics from such a mixture is not feasible by traditional “float-sink” technology.

### BACKGROUND OF THE INVENTION

Mixtures of particles of different materials have limited value due to the significant differences in physical properties of each material. Value can be realized by separating the particulate mixture into two or more streams or populations in which each stream has a greater proportion of a respective material as compared to the previous particulate mixture.

Various processes are known for separating mixtures of ground or comminuted plastics, such as in the fields of recycling and material reclamation. A frequently used separation process is a float-sink operation in which a mixture or feed of various plastics is introduced into a liquid or other medium having a specific density. Materials having a density greater than that of the medium sink, and materials having a density less than that of the medium float. This strategy is useful for a wide range of material mixtures.

However, float-sink operations are generally ineffective in separating materials having the same or similar densities. And so, it is necessary to utilize a different separation technique. Previously, froth flotation processes have been used to separate materials having the same or similar densities. Froth flotation separation processes rely upon differences in the “wettability” of materials, and specifically, their relative degrees of hydrophilicity or hydrophobicity. Froth flotation likely originated in the mining and ore processing industry, as exemplified by U.S. Pat. Nos. 1,911,865; 2,105,294; 2,188,932; and 2,588,443. Although apparently useful for separation and/or concentration of ores and minerals, the processes described in those patents are typically performed using liquid mill concentrates and adding a flotation agent such as fish oil, crude oil, kerosene, or the like to alter the wettability characteristics of the ores.

Froth flotation processes have also been used to separate plastic materials having the same or similar densities. Examples of processes for separating mixtures of various plastics by froth flotation are set forth in U.S. Pat. Nos. 3,925,200; 3,926,790; 3,926,791; 3,985,650; 4,167,477; 4,132,633; 5,234,110; 5,248,041; and 5,377,844.

Fluorinated plastics are increasingly used in many applications. The growing popularity of fluorinated plastics is likely due to their often superior chemical resistance, thermal stability, cryogenic properties, low coefficient of friction, low surface energy, low dielectric constant, high volume and surface resistivity, and flame resistance. Fluorinated plastics are often used as liners to provide a process surface because of their resistance to chemical attack. They provide durable, low maintenance and economical alternatives to more exotic metals for use at high temperatures without introducing impurities. Their beneficial electrical properties also make fluorinated plastics highly valuable in electronic and electrical applications as insulation, such as in a wide range of data communications. In automotive and office equipment, mechanical properties of fluorinated plastics are beneficial in low-friction bearings and seals that resist attack by hydrocarbons and other fluids. In food processing, the Food and Drug Administration approved a wide range of grades as fabrication material for equipment. In housewares, fluorinated plastics are applied as nonstick coatings for cookware and appliance surfaces. Medical articles such as surgical patches and cardiovascular grafts rely on the long-term stability of fluorinated plastics as well as their low surface energy and chemical resistance. For airports, stadiums, and other structures, glass fiber fabric coated with Teflon is fabricated into roofing and enclosures. Teflon provides excellent resistance to weathering, including exposure to ultraviolet rays in sunlight, flame resistance for safety, and low surface energy for soil resistance and easy cleaning.

Although fluorinated plastics have numerous benefits, they are typically more costly to produce than polyolefins and many other plastics due to their associated capital costs and the relatively high cost of fluorine. Polymerization and finishing of these resins frequently requires processing of highly flammable hazardous materials, thus mandating the use of expensive construction materials and elaborate equipment.

In view of these relatively high cost and valuable materials, a strong incentive exists to reclaim and recycle fluorinated plastics. As far as is known, no salvage or reclamation process is known for the specific recovery of fluorinated plastics, particularly from a mixture of other plastics having the same or similar density. Accordingly, it would be desirable to provide a process whereby fluorinated plastics could be readily recovered from a mixture of ground or comminuted plastics, and particularly from a mixture of plastics having the same or similar density.

It would also be beneficial to adapt a froth flotation operation so that fluorinated plastics could be readily recovered from a mixture comprising one or more other plastics having the same or similar density.

### SUMMARY OF THE INVENTION

The difficulties and drawbacks associated with previous separation operations are overcome in the present invention providing various processes and systems for separating and recovering fluorinated plastics.

In one aspect, the present invention provides a process for recovering fluorinated plastic particles from a mixture of solid particles, wherein at least a portion of the solid particles have the same or similar density as the fluorinated particles. The process comprises providing a froth flotation system. The system includes a vessel, and an aerated aqueous medium in the vessel. The process also comprises introducing the mixture of solid particles and fluorinated plastic particles into the aerated aqueous medium, whereby at least a portion of the fluorinated plastic particles separate from the mixture.

In another aspect, the present invention provides a process for separating fluorinated plastic from a mixture of plastic particulates. The mixture includes fluorinated plastic having a first density and non-fluorinated plastic having a second density. The process comprises providing a froth flotation system including a vessel and a liquid aerated medium in the vessel. The process also comprises introducing the mixture of plastic particulates to the liquid medium. And, the process comprises adding an effective amount of a carboxylic acid additive to the medium to promote separation of at least a portion of the fluorinated plastic from the non-fluorinated plastic.

In yet another aspect, the present invention provides a process for recovering at least one fluorinated plastic from a comminuted mixture including the at least one fluorinated plastic, and at least one non-fluorinated plastic, in a froth flotation system having an aerated aqueous medium contained in a vessel. The process comprises introducing a carboxylic acid additive to the aqueous medium to obtain a pH value in the range of from about 5 to about 3. The process also comprises adding the comminuted mixture to the aqueous medium, whereby the at least one fluorinated plastic floats in the vessel and at least a portion of the non-fluorinated plastic sinks in the vessel thereby enabling the fluorinated plastic to be recovered.

As will be realized, the invention is capable of other and different embodiments and its several details are capable of modifications in various respects, all without departing from the invention. Accordingly, the drawings and description are to be regarded as illustrative and not restrictive.

### BRIEF DESCRIPTION OF THE DRAWINGS

FIG. 1 is a schematic illustration of a froth flotation unit utilized in association with the present invention.

FIG. 2 is a schematic flow chart illustrating a system of multiple froth flotation units utilized in association with the present invention.

### DETAILED DESCRIPTION OF THE EMBODIMENTS

The present invention relates to reclaiming one or more fluorinated components, and particularly fluorinated plastics such as polytetrafluoroethylene (PTFE), copolymers of ethylene and PTFE (ETFE), copolymers of hexafluoropropylene and PTFE (FEP) etc., from a mixture of components at least some of which have the same or similar densities as the fluorinated components by means of froth flotation. Such components are not amenable to separation by traditional float-sink technology.

Throughout the description of the present invention and its various preferred aspects, reference is made to separating or recovering at least one fluorinated plastic from other plastics and potentially other solids having the same or similar density or specific gravity as that of the at least one fluorinated plastic of interest. The phrase “the same or similar density” (or specific gravity) refers to densities or ranges of densities of the fluorinated plastic(s) at issue and other materials in the mixture which are within about ±30% of each other, or as is more typical with density ranges resulting from multiple materials, overlap each other to some extent.

In the case of recycled plastics, for example, one may encounter a stream of particles consisting of fluoropolymers such as FEP, ETFE, or PTFE admixed with filled polyvinyl chloride (PVC) rubber, silicone, filled polyethylene, etc. from which it is desirable to extract a stream rich in fluoropolymer particles. Since all of the particles have approximately the same or similar densities, e.g. within the range of 1.4 g/cm³ to 2.4 g/cm³, it is not possible to effectively separate these particles by a float-sink operation that differentiates particles based on density.

Froth flotation can be used to effect a separation based on the relative hydrophobicity of the particles. Since fluoropolymers are the most hydrophobic materials in the previously noted representative mixture, they tend to more selectively report to the surface of the froth flotation liquid. The selectivity is based on the probability that a sufficient number of air bubbles in the froth liquid will attach to a fluoropolymer particle to render it sufficiently buoyant to report to the surface of the froth liquid from which it can then be removed by skimmers or the like.

As noted, froth flotation has been described for coal beneficiation, numerous mineral processes, and a few plastics separations. However, as far as is known, froth flotation has never been described in the literature specifically for the recovery and purification of fluorinated plastics.

Heretofore, certain mixtures of particles having the same or similar densities such as plastics have been separated by froth flotation. As noted, froth flotation causes particles to separate based on the relative hydrophobicity of a particle's surface, with the more hydrophobic particles adhering to the bubbles and reporting to the surface of the liquid, while the less hydrophobic particles (i.e. more hydrophilic particles) tend to “wet”, and sink in the process fluid.

Prior processes using froth flotation for plastics separation require a conditioning step or other pretreatment operation in which the chemical characteristics of the surface of one or more types of particles are altered to make those species more or less hydrophobic than other species prior to or during froth flotation. This requirement is generally undesirable since such conditioning or pretreatment operations further increase process complexity, cost, and time requirements. In addition, requiring such conditioning or pretreatment operations introduces additional variables into the process and can detrimentally affect process quality and repeatedability.

The present invention is based upon a discovery that the surface characteristics of fluorinated plastics can be selectively altered to render them more hydrophobic than other non-fluorinated plastics, by incorporation of one or more particular agents in the froth flotation medium. Specifically, it has been discovered that by adding a carboxylic acid to the froth flotation medium, both yield and purity of the hydrophobic stream can be dramatically improved in a froth flotation system. This effect is previously unreported in the literature. Furthermore, the present invention is based upon an unexpected positive impact of simple carboxylic acids such as acetic acid on the yield and selectivity for fluorinated plastics in the floating product stream of a froth flotation operation. Moreover, another significant advantage of the present invention, is that pre-conditioning or other treatments of the mixture of plastic particles is not required.

### Fluorinated Plastics

A wide array of fluorinated plastics (also termed fluoropolymers, fluorocarbon resins, fluorine plastics, and fluoroplastics) may be separated and/or recovered by the present invention. The term “fluorinated plastics” as used herein encompasses fluoropolymers, fluorocarbon resins, fluorine plastics and fluoroplastics; and refers to polymers in which one or more hydrogens have been replaced by fluorine and in some cases chlorine and/or other groups. These materials are widely used in view of their excellent chemical resistance and relatively high heat resistance. The three primary groups of fluorinated plastics are (i) fluorocarbons, (ii) chlorotrifluoroethylene, and (iii) fluorohydrocarbons. Each of these groups is described as follows.

Two main categories of the first group generally designated as fluorocarbons include tetrafluoroethylene (PTFE or TFE) and fluorinated ethylene propylene (FEP). PTFE is the most commonly used fluorinated plastic. Another type of fluorocarbon is perfluoroalkoxy (PFA) resins, which are similar to FEP. Yet another common fluorocarbon is ethylene tetrafluoroethylene (ETFE). This second group generally includes fluorinated chlorinated plastics.

The second group of chlorotrifluoroethylene (CTFE or CFE) or rather polychlorotrifluoroethylene (PCTFE) is typically stronger and more rigid than most fluorocarbons. CTFE plastics are frequently compounded with a wide range of fillers and/or additives to tailor their physical properties. Another type of similar material is ethylene chlorotrifluoroethylene (ECTFE).

The third group of fluorinated plastics is fluorohydrocarbons which are typically categorized as either polyvinylidene fluoride (PVF₂) or polyvinyl fluoride (PVF).

The present invention is particularly directed to recovering and/or separating one or more of these fluorinated plastics from one or more non-fluorinated plastics, and specifically, from a mixture of plastic materials in which at least some of the materials have the same or similar density as the one or more fluorinated plastics to be recovered. The preferred embodiment processes can also be tailored to recover two or more of these various fluorinated plastics from mixtures of solid particulates.

### Preferred Processes

The present invention provides a process for separating and recovering ground or comminuted fluorinated plastics from a mixture comprising one or more other particulate polymers having the same or similar density as the fluorinated plastic(s) of interest. The process is preferably applied to a solid feedstock of particulate materials such as obtained in operations producing scrap and shredder residue.

Examples of streams utilized as feedstocks in various preferred embodiments of the invention include mixtures of particles generated in the recycling of wire and cable, automotive shredding (i.e. automotive shredder residue, ASR), electronic scrap shredding (electronic scrap residue, ESR), mixed residue from injection molding or extruding operations (i.e. mixed “bleeders”), mixtures of post industrial particles, and mixtures of post consumer particles.

Generally, the processes of the present invention can be applied to feedstocks comprising a mixture of particulate matter and typically including at least one population of particulate fluorinated plastics and at least one other population of particulate plastics, such as non-fluorinated plastics. Suitable feedstock streams for the preferred embodiment processes have a majority of particles in the density range of from about 1.4 g/cm³ to about 2.4 g/cm³. However, it is to be appreciated that the present invention can be applied to other feedstocks and feedstock streams, such as feedstocks having a majority of particles with densities outside of this range, such as having densities less than 1.4 g/cm³ or more than 2.4 g/cm³, for example. Furthermore, it will be appreciated that although the present invention is primarily directed to applications for separating fluorinated plastics from other plastics some of which having the same or similar densities as the fluorinated plastics of interest; the present invention may also find utility in separating fluorinated plastics from material mixtures having different densities than the fluorinated plastics.

Generally, in accordance with the preferred embodiment processes, a particulate feedstock or feedstock stream is introduced into a froth flotation unit or system. As noted, froth flotation involves the admixing of feedstock particles with water and air. A number of fabricators market froth flotation technology, including Wemco of FLSmidth Dorr-Oliver Eimco USA Inc., of Salt Lake City, Utah; Denver, which is available through Metso Minerals of Helsinki, Finland; and Outokumpu Mintek of Helsinki, Finland. Since the air in these units is introduced below the surface of the water, they are referred to as “sub aeration” devices. It is also possible to spray a fluid or a slurry onto the surface of a liquid, and generate bubbles. These type of operations are referred to as “spray float”. In either case, a stream rich in hydrophobic particles is removed from the surface or upper region of the tank, and a stream rich in hydrophilic particles is removed from the bottom or lower region of the tank.

The froth flotation units can be operated as batch, semi-continuous or continuous. They can be operated as single stage or multi-stage. They can be operated at different air flow rates, pressures, etc. They be arranged into various classes of separation commonly referred to as “roughers”, “cleaners” and “scavengers”.

The yield and quality of the floating product stream is generally a function of the chemical composition of the particles in the feed mixture, the operating conditions of the froth flotation cell, and the type and quantity of additives added to the process to improve yield and selectivity.

The terms “float product” or “float output” are periodically used herein to refer to one or more outputs of a froth flotation operation which are generally obtained from an upper region and typically from the surface of the liquid medium contained in the vessel. As noted herein, these output(s) typically include higher proportions of the hydrophobic components. Conversely, the terms “sink product” or “sink output” are used to refer to one or more outputs of a froth flotation operation which are generally obtained from a lower region and typically from the bottom of the liquid medium contained in the vessel. These output(s) typically include higher proportions of the hydrophilic components.

In accordance with the present invention, it has been surprisingly and unexpectedly discovered that the addition of one or more carboxylic acids has a dramatic and beneficial impact on the yield and selectivity of a process involving separation and recovery of one or more fluorinated plastics from a mixture of plastics having the same or similar density in a froth flotation operation.

### Recovering Fluorinated Plastics

The present invention will now be described with respect to reclaiming one or more types of fluorinated polymer particles from a mixture of particles obtained from the recycling of wire and cable insulation. It will be understood that, as previously noted, generally any mixture of particles containing fluorinated plastic particles and other particles having varying degrees of hydrophobicity can serve as a feedstock for this process.

A suitable feedstock for a preferred embodiment process of the present invention is obtained from untreated wire and cable insulation by applying various cleaning and float-sink operations such as those described in US Patent Publication 2006/0118469 to Bork et al. A typical specific gravity range for a feedstock mixture suitable for this preferred embodiment process is from about 1.40 to about 2.40. Such a mixture comprises fluorocarbons such as FEP, ETFE, and PTFE; and filled polyvinyl chloride (PVC), rubber, silicone, and crossed-linked and filled polyethylene. This mixture cannot be further separated by specific gravity or density-based techniques because the specific gravity ranges of each of the types of particles overlaps.

The mixture of solid particles is preferably admixed with sufficient water to create a slurry of from about 0.1 to about 30 percent by weight solids, and subjected to froth flotation. No conditioning step is required. No reaction of the plastic particles with conditioning chemicals to alter the surface state of the particles is required.

In accordance with a preferred embodiment process of the present invention, one or more carboxylic acids is added to a froth flotation system to enhance the flotation of fluoropolymer particles. Examples of suitable carboxylic acids include acetic, oxalic, and citric acids, with acetic acid the most preferred. Additional examples of suitable carboxylic acids are described in greater detail herein.

The more hydrophobic particles are removed from the top of the froth flotation tank by skimming or other means, while the less hydrophobic particles are removed from the bottom of the froth flotation tank.

In a preferred aspect of the present invention, the yield and purity of the floating stream can be manipulated by adjusting the amount of carboxylic acid added. The concentration of carboxylic acid in the solution is easily monitored by the pH of the fluid. In general, pH values of from about 5 to about 3 have been found to be useful. However, the present invention includes the use of froth flotation aqueous mediums having greater pH values such as up to about 6.5 or more, and lesser pH values such as from about 2.5 for example.

The float output stream from a first froth flotation cell can be deemed final product, or can be subjected to additional froth flotation steps to further improve quality. These additional froth flotation steps can be at the same or a different carboxylic acid concentration from the first step. The additional flotation steps can also use a different carboxylic acid or no carboxylic acid.

In a like manner, the sink product from the first froth flotation cell can be deemed final product, or can be subjected to additional froth flotation steps to further improve quality or to recover additional hydrophobic materials. These additional froth flotation steps can be at the same or a different carboxylic acid concentration from the first step. The additional flotation steps can also use a different carboxylic acid or no carboxylic acid.

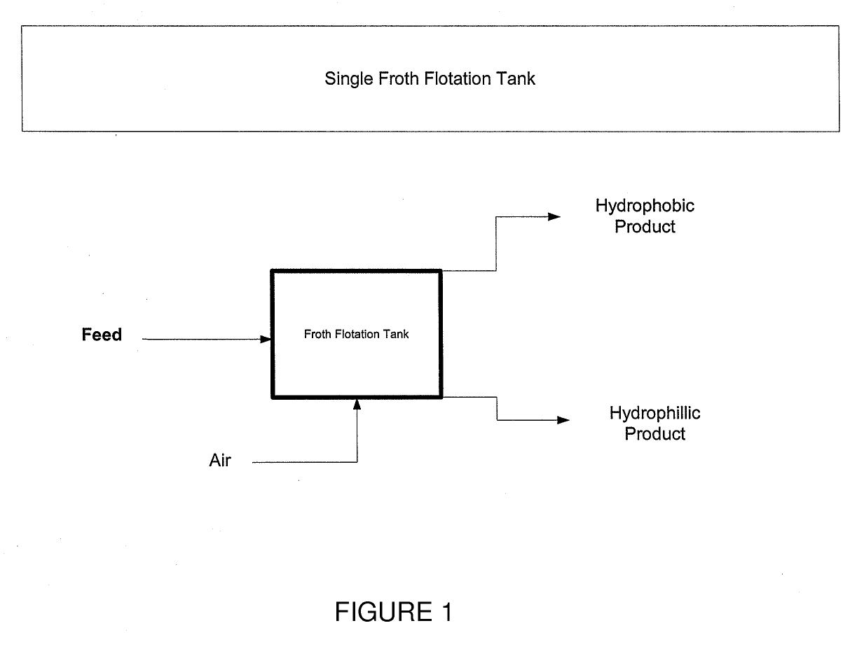

FIG. 1 is a schematic illustration of a single froth flotation unit operation or cell 10. The froth flotation unit 10 comprises a vessel 100 adapted to receive at least one feed such as feed 102 and provide outputs, such as first and second outputs 110 and 120, respectively. The vessel 100 is adapted to receive at least one feed and provide the noted outputs, and so includes provisions such as inlets, outlets, and connection components. The vessel 100 also is adapted to retain a liquid medium, which is preferably an aqueous liquid. It is also preferred that the vessel include provisions for introducing air into the liquid medium, preferably at one or more lower regions of the vessel so that the air is dispersed relatively uniformly throughout the tank and rises upward from the lower region(s) of the vessel. It is also contemplated to provide provisions for agitating or stirring the aerated liquid medium in the vessel. The vessel 100 may further include one or more screens or filters at the outputs to prevent excessively sized particles or objects from exiting the vessel. As previously noted, the froth flotation unit typically utilizes one or more skimmers or like assemblies to selectively remove or withdraw particulate material residing in an upper region of the vessel, typically as a result of the froth flotation operation.

A typical operation of the froth flotation cell 10 is as follows. Feed 102 is introduced into the vessel 100. Feed 102 can be in any of the previously described forms, however typically is in the form of a ground or comminuted particulate mixture including at least two types of plastics having the same or similar density, and which are to be separated. The vessel 100 contains an aqueous medium through which air 104 is administered, to form an aqueous aerated medium.

The term “aerated” is used herein to refer to the liquid medium of a froth flotation vessel or system receiving air or having previously received air. Typically, such air is administered below the surface of the liquid medium and upon entering the liquid, tends to rise upward in the form of bubbles. The present invention includes other strategies for forming bubbles or otherwise introducing air in a liquid medium of a froth flotation vessel or system. Furthermore, it is contemplated that other gases or vapors may be used instead of air. However, air is preferred in view of its abundancy and essentially free cost.

As a result of differences in the hydrophobicity or hydrophilicity characteristics of the various particulates, certain particulates exhibiting a greater degree of hydrophobicity than other particulates tend to rise in the vessel and collect along or proximate the top surface of the medium. These particulates can be withdrawn or discharged from the vessel 100 as an output 110, i.e. the more hydrophobic product. The particulates exhibiting a greater degree of hydrophilicity than other particulates tend to collect in the lower regions of the vessel, and can be withdrawn or discharged from the vessel 100 as an output 120, i.e. the more hydrophilic product.

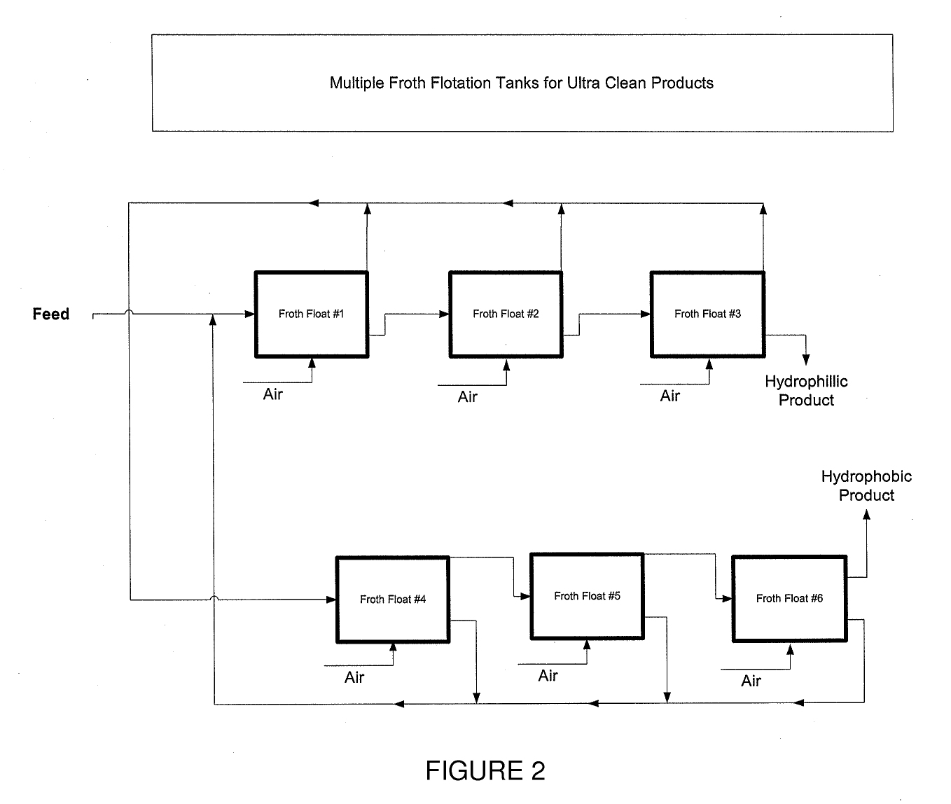

FIG. 2 is a process flow schematic illustrating a froth flotation system 50 comprising a plurality of froth flotation cells. Each cell includes a vessel such as vessels 200, 300, 400, 500, 600, and 700, each of which is preferably similar or the same as the previously described vessel 100. The present invention includes the various vessels being in communication with one or more other vessels in nearly any configuration. It will be appreciated that the configuration depicted in FIG. 2 is merely one of potentially many different configurations encompassed by the present invention. With continued reference to FIG. 2, the preferred embodiment system 50 will now be described. Feed 202 is introduced to vessel 200, and specifically, to an aqueous aerated medium retained therein. A first output 210 generally containing hydrophobic components, and a second output 220 generally containing hydrophilic components are produced. The second output 220 is fed to the vessel 300 which produces a first output 310 generally containing hydrophobic components, and a second output 320 generally containing hydrophilic components. The second output 320 is fed to the vessel 400 which produces a first output 410 generally containing hydrophobic components, and a second output 420 generally containing hydrophilic components. The first outputs of vessels 200, 300, and 400, i.e. the outputs 210, 310, and 410 generally containing hydrophobic components, are directed as feed to the vessel 500. Introduction of that feed to vessel 500 produces a first output 510 that generally contains hydrophobic components, and a second output 520 that generally contains hydrophilic components. The first output 510 is directed to vessel 600 which produces a first output 610 which generally contains hydrophobic components, and a second output 620 that generally contains hydrophilic components. The first output 610 is directed to vessel 700 which produces a first output 710 which generally contains hydrophobic components, and a second output 720 that generally contains hydrophilic components. The second outputs of vessels 500, 600, and 700, i.e. the outputs 520, 620 and 720 generally containing hydrophilic components, are directed to the vessel 200 and preferably mixed or otherwise combined with the feed 202. Each of the vessels 200-700 preferably receives a supply of air, depicted in FIG. 2 as air flows 204, 304, 404, 504, 604, and 704.

The output 420 is rich in hydrophilic product. And, the output 710 is rich in hydrophobic product. For a process in which the feed 202 comprises one or more fluorinated plastics, operation of the system 50 will produce the output 710 comprising a high proportion of fluorinated plastics.

The liquid mediums in the one or more vessels in the preferred embodiment processes of the invention can include any suitable liquid. Typically, the liquid medium will comprise a majority amount of water, and may further comprise one or more other liquids depending upon the particular application and particulate materials to be separated. And, in accordance with the present invention, the liquid medium comprises an effective amount of a carboxylic acid additive.

### Carboxylic Acid Additives

As noted, the present invention utilizes at least one carboxylic acid additive in one or more froth flotation operations. Generally, the carboxylic additive can include one or more of the carboxylic acids noted herein, or include one or more of these acids in combination with one or more other agents or additives. The one or more other agents or additives can include known agents used in froth flotation operations, and/or include other dispersants, pH buffers or modifiers, surfactants, chelating agents, solution property adjusters, or the like.

Carboxylic acids are organic acids characterized by the presence of a carboxyl group, which has the formula —C(═O)OH, usually written —COOH or —CO₂H. Carboxylic acids are Bronsted-Lowry acids, and are proton donors. Salts and anions of carboxylic acids are called carboxylates. The simplest series of carboxylic acids are the alkanoic acids, R—COOH, where R is a hydrogen or an alkyl group. Compounds may also have two or more carboxylic acids groups per molecule. Carboxylic acids are polar, and form hydrogen bonds with each other. At high temperatures, in vapor phase, carboxylic acids usually exist as dimeric pairs. Lower carboxylic acids (1 to 4 carbons) are miscible with water, whereas higher carboxylic acids are very much less soluble due to the increasing hydrophobic nature of the alkyl chain. They tend to be rather soluble in less polar solvents such as ethers and alcohols.

The carboxylic acid additive for use in the preferred embodiment processes may for example include (i) straight chain, saturated carboxylic acids such as those set forth below in Table 1, (ii) dicarboxylic acids containing two carboxyl groups, (iii) tricarboxyl acids containing three carboxyl groups, and (iv) combinations of these acids.

Examples of straight chain, saturated carboxylic acids are listed below in Table 1. It will be appreciated that the acids having 1-4 carbon atoms are preferred for use in aqueous mediums. A most preferred carboxylic acid from this group is acetic acid. Acids having 5 or more carbon atoms may be suitable for mediums comprising alcohols or other agents.

TABLE 1
Straight-Chained, Saturated Carboxylic Acids

| Carbon | | | |
|---|---|---|---|
| atoms | Common name | IUPAC name | Chemical formula |
| 1 | Formic acid | Methanoic acid | HCOOH |
| 2 | Acetic acid | Ethanoic acid | CH₃COOH |
| 3 | Propionic acid | Propanoic acid | CH₃CH₂COOH |
| 4 | Butyric acid | Butanoic acid | CH₃(CH₂)₂COOH |
| 5 | Valeric acid | Pentanoic acid | CH₃(CH₂)₃COOH |
| 6 | Caproic acid | Hexanoic acid | CH₃(CH₂)₄COOH |
| 7 | Enanthic acid | Heptanoic acid | CH₃(CH₂)₅COOH |
| 8 | Caprylic acid | Octanoic acid | CH₃(CH₂)₆COOH |
| 9 | Pelargonic acid | Nonanoic acid | CH₃(CH₂)₇COOH |
| 10 | Capric acid | Decanoic acid | CH₃(CH₂)₈COOH |
| 12 | Lauric acid | Dodecanoic acid | CH₃(CH₂)₁₀COOH |
| 16 | Palmitic acid | Hexadecanoic acid | CH₃(CH₂)₁₄COOH |
| 18 | Stearic acid | Octadecanoic acid | CH₃(CH₂)₁₆COOH |

As noted, dicarboxylic acids may also be used as the carboxylic acid additive. Examples of dicarboxylic acids include aldaric acid, oxalic acid, malonic acid, malic acid, fumaric acid, succinic acid, glutaric acid, and adipic acid. A most preferred dicarboxylic acid is oxalic acid.

Tricarboxylic acids may also be used as the carboxylic acid additive. Examples of tricarboxylic acids include citric acid, isocitric acid, aconitic acid, and propane-1,2,3-tricarboxylic acid (tricarballylic acid, carballylic acid). A most preferred tricarboxylic acid is citric acid.

Although not wishing to be bound to any particular theory, it is believed that the use of smaller chain carboxylic acids such as acetic acid and citric acid is favored over other classes of chemical agents such as surfactants which may have carboxylic acid groups. And thus the term “carboxylic acid additive” refers to carboxylic acids, such as those noted herein and does not include other types of chemicals or organic agents having one or more carboxylic acid groups, such as various surfactants. Furthermore, use of surfactants in froth flotation mediums would likely be detrimental to the preferred embodiment processes. That is, for most plastics separations it is preferred that surface tension characteristics of the liquid medium not be reduced. This strategy is believed to promote the liquid surface functioning to “hold” or otherwise assist in retaining hydrophobic particles along an upper region of the liquid medium. By definition, adding surfactants to the liquid medium would reduce the surface tension. Additional reasons exist as to why carboxylic acids are preferred for use as the additive. Addition of carboxylic acids to an aqueous medium results in reducing the pH of the medium, whereas upon adding the noted surfactants, this typically does not occur or at least not to the same extent. An acidic medium may, in certain situations, further promote separations based upon wettability characteristics of materials such as plastics to be separated. Furthermore, use of carboxylic acids is favored over surfactants in view of higher costs typically associated with surfactants, and particularly exotic surfactants. Disposal and environmental concerns also tend to favor the use of short chain carboxylic acids as opposed to long chain surfactants

The carboxylic acid additive may be administered directly into the froth flotation tank and include combinations of one or more of the previously noted carboxylic acids, dicarboxylic acids, and tricarboxylic acids, for example. Moreover, the carboxylic acid additive may further comprise one or more of these acids in combination with one or more known froth flotation agents.

In addition to the various flotation aids noted herein, one or more of the following agents may be used in the froth flotation system to promote separation of the materials: organic colloids which alter the hydrophilic/hydrophobic surface characteristics of the materials. Suitable examples of organic colloids which can be used in the present invention include tannic acid, a quebracho extract, gelatin, glue, saponin and the like. Other examples of agents include sodium lignin sulfonate and calcium lignin sulfonate. Further examples include pine oil, cresylic acid (also known as xylenol), eucalyptus oil, camphor oil, a derivative of a higher alcohol, methylisobutyl carbinol, pyridine, o-toluidine and the like. Yet another example of a suitable agent is sodium silicate. Furthermore, depending upon the liquid medium used and the composition of the feed, it may also be possible to utilize one or more of the following agents: polyoxyparafins, alcohols such as methyl isobutyl carbinol (MIBC), and various polyglycols.

It is to be appreciated that the present invention provides a significant advantage over previously known plastic separations using froth flotation. Namely, the present invention processes simply entail adding an effective amount of the carboxylic acid additive to the froth flotation medium. No operation is required in which the feed must be pretreated or conditioned. Nor are any operations required in which materials to be separated are subjected to a soaking or other contacting step, which as previously noted leads to increased costs and process complexity.

### EXAMPLES

The various preferred embodiment aspects will be better understood by reference to the following examples which serve to illustrate but not to limit the present invention.

A feedstock was derived from the reclamation of insulation from recycled wire and cable. previously separated, to create a mixed stream of particles in a specific gravity range of 1.4 to 2.4. The particulate mixture included FEP, filled PVC, rubber, silicone, and filled polyethylene.

A feedstock containing fluoropolymer particles was subjected to four stages of froth flotation using a spray float type apparatus. Each test was conducted at room temperature, and used a different concentration of a carboxylic acid.

The floating and sinking products were all dried and weighed to determine yield.

The floating products were then subjected to analytical testing to determine the percentage of contaminants (i.e. PVC, rubber, silicone, and filled PE) that were present in that product. All floating products contained less than 1% contaminants. Results are presented in Tables 2A-2D set forth below.

The data indicate that increasing amounts of acetic acid are most effective at improving the yield and selectivity for FEP. Citric acid has a similar effect, albeit not as large as that achieved by similar quantities of acetic acid.

Mineral acids such as H₂SO₄ and HCl, while able to depress pH, have a minimal impact on yield and selectivity.

TABLE 2A
FEP Recovery with Acetic Acid

| | pH of Solution | | | | | | | | | | |
|---|---|---|---|---|---|---|---|---|---|---|---|
| | 6.84 | 6.25 | 5.75 | 5.28 | 4.96 | 4.69 | 4.45 | 4.34 | 4.20 | 4.04 | 3.66 |
| % float | 24.4% | 26.4% | 30.6% | 32.0% | 34.3% | 37.0% | 48.5% | 60.7% | 78.0% | 81.6% | 98.2% |
| % sink | 75.6% | 73.6% | 69.4% | 68.0% | 65.7% | 63.0% | 51.5% | 39.3% | 22.0% | 18.4% | 1.8% |

TABLE 2B
FEP Recovery with Citric Acid

| | pH of Solution | | | | |
|---|---|---|---|---|---|
| | 6.84 | 5.14 | 4.68 | 4.08 | 3.72 |
| % float | 24.4% | 29.5% | 29.3% | 34.9% | 34.0% |
| % sink | 75.6% | 70.5% | 70.7% | 65.1% | 66.0% |

TABLE 2C
FEP Recovery with Sulfuric Acid

| | pH of Solution | | | | |
|---|---|---|---|---|---|
| | 6.84 | 5.25 | 4.7 | 4.12 | 3.64 |
| % float | 24.4% | 26.1% | 26.0% | 29.4% | 30.2% |
| % sink | 75.6% | 73.9% | 74.0% | 70.6% | 69.8% |

TABLE 2D
FEP Recovery with Hydrochloric Acid

| | pH of Solution | | | | |
|---|---|---|---|---|---|
| | 6.84 | 5.29 | 4.72 | 4.15 | 3.75 |
| % float | 24.4% | 26.9% | 28.0% | 29.6% | 29.9% |
| % sink | 75.6% | 73.1% | 72.0% | 70.4% | 70.1% |

Many other benefits will no doubt become apparent from future application and development of this technology.

All patents, published applications, and articles noted herein are hereby incorporated by reference in their entirety.

As described hereinabove, the present invention solves many problems associated with previous type strategies and processes. However, it will be appreciated that various changes in the details, materials and operations, which have been herein described and illustrated in order to explain the nature of the invention, may be made by those skilled in the art without departing from the principle and scope of the invention, as expressed in the appended claims.

What is claimed is:

1. A process for recovering fluorinated plastic particles from a mixture of solid particles, wherein at least a portion of the solid particles have the same or similar density as the fluorinated particles, the process comprising:
providing a froth flotation system, the system including a vessel, and an aerated aqueous medium in the vessel;
introducing the mixture of solid particles and fluorinated plastic particles into the aerated aqueous medium, whereby at least a portion of the fluorinated plastic particles separate from the mixture.

2. The process of claim 1 further comprising:
adding a carboxylic acid additive to the aerated aqueous medium, whereby flotation of the fluorinated plastic particles is promoted.

3. The process of claim 2 whereby sinking of the solid particles is also promoted.

4. The process of claim 2 wherein the carboxylic acid additive comprises an agent selected from the group consisting of acetic acid, citric acid, and a combination of both.

5. The process of claim 2 wherein the froth flotation system includes a first output including floating fluorinated plastics, and a second output including sinking solid particles, the process further comprising:
introducing at least one of the first and the second outputs as a feed to a second froth flotation system.

6. The process of claim 5 further comprising:
adding a carboxylic acid additive to an aqueous medium in the second froth flotation system.

7. The process of claim 6 wherein a concentration of the carboxylic acid additive in the aqueous medium of the second froth flotation system is different than a concentration of the carboxylic acid additive in the aqueous medium of the first froth flotation system.

8. The process of claim 6 wherein the carboxylic acid additive in the aqueous medium of the second froth flotation system is different than the carboxylic acid additive in the aqueous medium of the first froth flotation system.

9. The process of claim 1 wherein the fluorinated plastic includes polytetrafluoroethylene (PTFE).

10. The process of claim 1 wherein the fluorinated plastic includes a fluorinated chlorinated plastic.

11. The process of claim 1 wherein fluorinated ethylene propylene (FEP) is separated from a mixture comprising FEP, polyvinyl chloride (PVC), and filled polyethylene.

12. The process of claim 11 wherein the carboxylic acid additive includes acetic acid.

13. A process for separating fluorinated plastic from a mixture of plastic particulates, the mixture including fluorinated plastic having a first density and non-fluorinated plastic having a second density, the process comprising:
providing a froth flotation system including a vessel and a liquid aerated medium in the vessel;
introducing the mixture of plastic particulates to the liquid medium; and
adding an effective amount of a carboxylic acid additive to the medium to promote separation of at least a portion of the fluorinated plastic from the non-fluorinated plastic.

14. The process of claim 13 wherein the carboxylic acid additive is selected from the group consisting of (i) straight chain, saturated carboxylic acids, (ii) dicarboxylic acids, (iii) tricarboxylic acids, and (iv) combinations of (i)-(iii).

15. The process of claim 14 wherein the carboxylic acid additive further includes another agent.

16. The process of claim 13 wherein the fluorinated plastic is selected from the group consisted of (i) fluorocarbons, (ii) chlorotrifluoroethylene, (iii) fluorohydrocarbons, and (iv) combinations of (i)-(iii).

17. The process of claim 13 wherein the liquid medium comprises a majority proportion of water and the effective amount of a carboxylic acid additive is an amount such that the pH of the liquid medium is in the range of from about 5 to about 3.

18. The process of claim 13 wherein the carboxylic acid additive includes acetic acid.

19. A process for recovering at least one fluorinated plastic from a comminuted mixture including the at least one fluorinated plastic, and at least one non-fluorinated plastic, in a froth flotation system having an aerated aqueous medium contained in a vessel, the process comprising:
introducing a carboxylic acid additive to the aqueous medium to obtain a pH value in the range of from about 5 to about 3;
adding the comminuted mixture to the aqueous medium, whereby the at least one fluorinated plastic floats in the vessel and at least a portion of the non-fluorinated plastic sinks in the vessel thereby enabling the fluorinated plastic to be recovered.

20. The process of claim 19 wherein the carboxylic acid additive is selected from the group consisting of (i) straight chain, saturated carboxylic acids, (ii) dicarboxylic acids, (iii) tricarboxylic acids, and (iv) combinations of (i)-(iii).

21. The process of claim 20 wherein the carboxylic acid additive comprises a straight chain, saturated carboxylic acid.

22. The process of claim 21 wherein the straight chain, saturated carboxylic acid is acetic acid.

23. The process of claim 20 wherein the carboxylic acid additive comprises a tricarboxylic acid.

24. The process of claim 23 wherein the carboxylic acid is citric acid.

25. The process of claim 19 wherein the fluorinated plastic is polytetraluoroethylene (PTFE).

26. The process of claim 19 wherein the fluorinated plastic is a fluorinated chlorinated plastic.
